(19) United States
(12) Patent Application Publication
(10) Pub. No.: US 2011/0191228 A1
(43) Pub. Date: Aug. 4, 2011

(54) SYSTEM AND METHOD FOR TO BE ANNOUNCED (TBA) BOND TRADING

(76) Inventor: Lloyd ALTMAN, New York, NY (US)

(21) Appl. No.: 12/698,774

(22) Filed: Feb. 2, 2010

(51) Int. Cl. G06Q 40/00

(52) U.S. Cl. 705/37

(57) ABSTRACT

A system and method for bond trading and TBA bond contract trading. The system includes a bond contract buying module operable to perform activities related to buying a first bond contract and a bond contract selling module operable to perform activities related to selling a second bond contract. The first bond contract includes a first description of bonds that satisfy the first bond contract. The second bond contract includes a second description of bonds that satisfy the second bond contract. The system further includes a clearing entity communication module operable to communicate with a clearing entity regarding the activities related to the buying of the first bond contract and the selling of the second bond contract.

### FIELD OF THE INVENTION

Embodiments of the present invention are generally related to bond trading and securities trading.

### BACKGROUND OF THE INVENTION

The ability to raise money can be vital to the ongoing operations of a business or government entity. One such instrument for a business to raise money is a debt security, such as a bond. Once an entity has issued bonds, the bonds may be bought and sold on a bond market.

Each bond can have a variety of characteristics, thereby allowing bond issuers various levels of flexibility when issuing bonds. However, this variety of characteristics results in bond trading being relativity unique. For example, if an investor desires to invest in a 30 year bond with an “AAA” credit rating and particular maturity characteristics, the investor may call a dealer and provide these desired characteristics to the dealer. The dealer would then provide a list of bonds that meet the criteria, the quantities available, and the corresponding prices. The investor can then decide whether or not to purchase certain bonds based on the available bonds. Alternatively, the investor could browse though bonds via an online system. Then, upon finding bonds matching the desired criteria, the investor can choose whether to purchase the bonds. Thus, the bond purchase process can be a multi-step and multi-minute process. This results in bond trading being time intensive, which limits the number of bond trades. Further, an investor is limited to the bonds the dealer has currently in inventory. These limits in combination, limit the number of bond transactions and the liquidity in the bond market dramatically.

Thus, there exists a need to have more efficient bond trading and bond market processes.

### SUMMARY OF THE INVENTION

Accordingly, what is needed is a way to allow bond trading which is independent of a variety of individual bond characteristics. Embodiments of the present invention facilitate increased bond trading and liquidity as general descriptions of bonds may be traded via to be announced (TBA) bond contracts. Trading of bonds based on general descriptions, frees bond traders from trading in individual bonds, each having individual sets of characteristics. Such general descriptions result in time saving as individual bonds need not be browsed through. Inventory limits are further removed as settlement of TBA bond contracts with actual bonds occurs after the TBA bond contract is traded. Bond traders may thus trade in and out of general descriptions, and upon settlement time, a netting of securities owed to a counter party with the clearing entity may take place. Embodiments of the present invention thus make it easier for investors, asset mangers, and dealers to invest in bonds or other fixed income securities.

In one embodiment, the present invention is implemented as a method for buying TBA bond contracts. The method includes receiving a request to purchase a TBA bond contract (e.g., corporate or municipal TBA bond contract) and sending a request to register a purchase of the TBA bond contract with a clearing entity. The TBA bond contract may have been selected from a list of a plurality of TBA bond contracts. A request to post collateral to the clearing entity may optionally be sent. The method further includes receiving notification of lots of bonds and receiving lots of bonds to settle the TBA bond contract. In one embodiment, the notification may be received within a predetermined time before settlement of the TBA bond contract. The TBA bond contract can be sold prior to settlement in order to close the position.

In another embodiment, the present invention is implemented as a method for selling a TBA bond contract. The method includes receiving a request to sell a TBA bond contract (e.g., corporate or municipal TBA bond contract) and sending a request to register a sale of the TBA bond contract with a clearing entity. The TBA bond contract may have a general description based on receiving a plurality of bond characteristics. During a predetermined time period prior to settlement of the TBA bond contract, notification can be sent to the clearing entity of a lot of bonds that will be delivered during settlement. During settlement, the lot of bonds may be sent to settle the TBA bond contract. In one embodiment, collateral may be posted to the clearing entity as the TBA bond contract price changes. Another TBA bond contract may be purchased in order to close the position prior to settlement.

In yet another embodiment, the present invention is implemented as a system for TBA bond contract trading. The system includes a TBA bond buying module operable to perform activities related to buying a TBA bond contract (e.g., corporate or municipal TBA bond contract) and a TBA bond contract selling module operable to perform activities related to selling the TBA bond contract. The system further includes a clearing entity communication module operable to communicate with a clearing entity regarding the activities related to the buying and the selling of the TBA bond contract. In one embodiment, the system includes a collateral management module for posting and receiving collateral related to the TBA bond contract (e.g., for changes in price of TBA bond contracts or closing of TBA bond contract positions prior to settlement).

In another embodiment, the present invention is implemented as a bond contract clearing system. The system includes a registration module operable to receive requests to register a sale and a purchase of a TBA bond contract and a settlement module operable to net out a plurality of TBA bond contract positions between a seller of the bond contract and a buyer of the TBA bond contract. The system further includes a notification module operable to receive notification of lot of bonds to be used for settling the TBA bond contract. The system may also include a collateral management module operable to receive and receive collateral related to the bond contract.

In this manner, embodiments of the present invention allow trading of bonds based on TBA bond contracts. TBA bond contracts advantageously allow trading of bonds based on general descriptions, thereby increasing trading volume and liquidity in the bond market.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary TBA bond contract trading flow diagram, in accordance with an embodiment of the present invention.

FIG. 2 shows a flowchart of an exemplary process for buying a TBA bond contract, in accordance with an embodiment of the present invention.

FIG. 3 shows a flowchart of an exemplary process for closing a purchased TBA bond contract position, in accordance with an embodiment of the present invention.

FIG. 4 shows a flowchart of an exemplary process for selling a TBA bond contract, in accordance with an embodiment of the present invention.

FIG. 5 shows a flowchart of an exemplary process for closing a sold TBA bond contract position, in accordance with an embodiment of the present invention.

FIG. 6 shows a block diagram of exemplary components of a TBA bond contract trading system, in accordance with an embodiment of the present invention.

FIG. 7 shows an exemplary computing system environment, in accordance with an embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

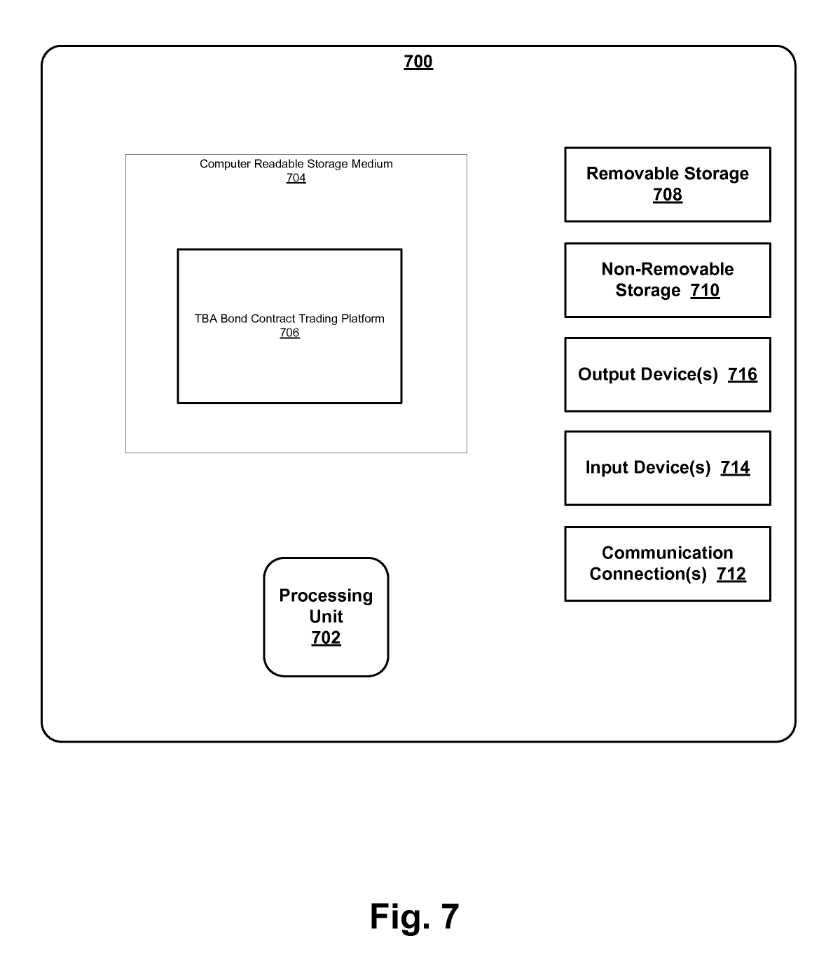

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of an integrated circuit (e.g., computing system 700 of FIG. 7), or similar electronic computing device, that manipulates and transforms data represented as physical (electronic) quantities within the computer system's registers and memories into other data similarly represented as physical quantities within the computer system memories or registers or other such information storage, transmission or display devices.

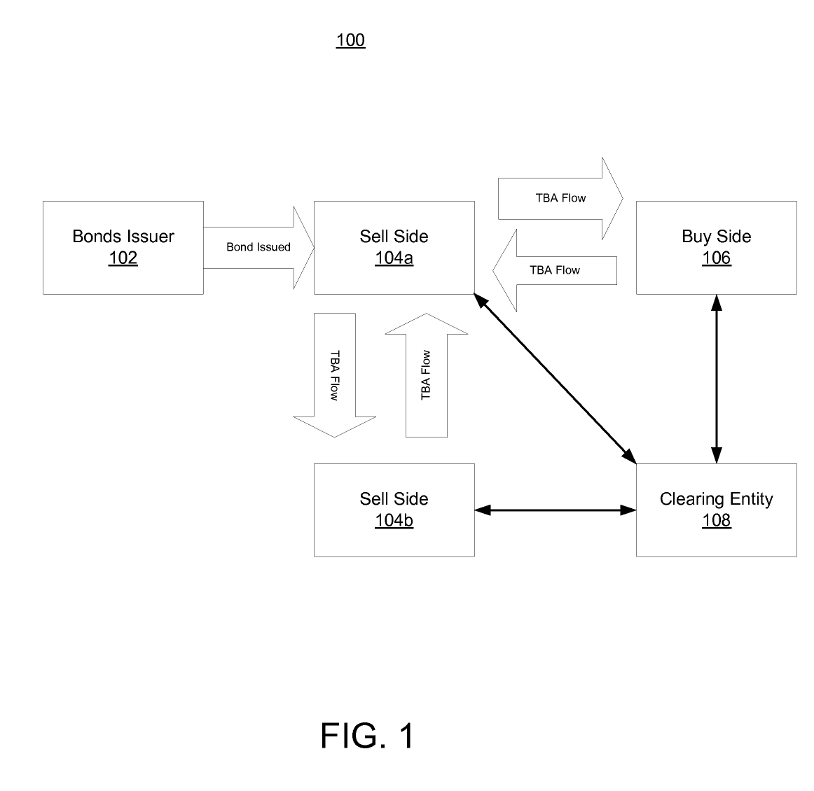

FIG. 1 shows an exemplary to be announced (TBA) bond contract trading flow diagram, in accordance with an embodiment of the present invention. A TBA bond contract is a bond-backed contract which has a general description that describes bonds that are to be delivered or substituted to fulfill the TBA bond contract upon settlement. The bonds are “to be announced” or notification sent thereof within a predetermined period (e.g., 48 hours) prior to the settlement of the TBA bond contract. TBA bond contract trading flow diagram 100 includes bonds issuer 102, sell sides 104a-b, buy side 106, and clearing entity 108.

Bonds issuer 102 is an entity that issues bonds to raise capital. Bond issuer 102 may be a variety of entities including corporations and municipalities. For example, bond issuer 102 may issue corporate bonds or municipal bonds. Bonds issuer 102 determines a variety of bond characteristics prior to issuing of bonds. General descriptions of currently traded TBA bond contracts can be used by bonds issuer 102 when selecting characteristics of bonds to issue. For example, bonds issuer 102 can use current TBA bond contract prices for their sector to determine when, and at what coupon, to issue new bonds.

Sell sides 104a-b purchase new bond issues from bonds issuer 102. Sell sides 104a-b may then sell the bonds on the secondary market to buy side 106. In one embodiment, sell sides 104a-b are primary bonds dealers. Sell sides 104a-b may include various entities in the dealer community including brokerages and other bond dealers.

TBA bond contract trading can advantageously allow an interdealer market between sell side 104a-b to become much more liquid. For example, bond market trading can shift from trading of specific CUSIPS (Committee on Uniform Security Identification Procedures or the 9-character alphanumeric security identifiers) of individual bonds to TBA bond contracts that represent multiple bonds (e.g., a plurality of CUSIPS).

Sell sides 104a-b may trade for a variety of purposes including proprietary trading (e.g., trading for their own positions) and positioning themselves for delivery of bonds on settlement. For example, sell side 104a may trade TBA bond contracts with other sell sides or dealers (e.g., sell side 104b) to purchase TBA bond contracts in order to be able to deliver the bonds that sell side 104a owes to a counter party (e.g., buy side 106). Sell side 104a may also purchase individual bonds for satisfying TBA bond contracts. Sell sides 104a-b may further trade TBA bond contracts to close TBA bond contract positions (e.g., buy back TBA bond contracts). It is appreciated that there are various way to fill the requirements or obligations of a TBA bond contract sold to a counter party. For example, the buying of a TBA bond contract may allow sell side 104a to close a TBA bond contract position by satisfying the delivery requirements of a previously sold TBA bond contract.

Schedules are be published (e.g., via an online system, print media, etc.) that provide information as to when TBA bond contracts are going to come to market and when TBA bond contracts are going to settle. Such schedules of rolling dates may be published well in advance, so that market users are aware when the settlements are to take place. Alerts (e.g., computer based alerts) can be set up such that market users can be prepared to deliver the bonds on settlement dates.

A variety of time periods and schedules may be used for TBA bond contract settlement. TBA bond contracts can be scheduled to settle each Friday at three PM; and starting 24 to 48 hours before that, TBA bond contract sellers may start substituting bonds for TBA bond contracts. For example, scheduling corporate TBAs bond contracts to settle every two weeks or twice a month may be sufficient. Municipal TBA bond contracts may have a settlement scheduled each month. In one embodiment, TBA bond contract settlement dates follow a convention similar to agency market dates.

TBA bond contract trading ends at a predetermined time before settlement. During this predetermined time before settlement, TBA bond contract traders (e.g., sell side 104a) that are to deliver bonds may provide information regarding the bonds that will be used to fulfill the TBA bond contract obligations. The information on the bonds to be delivered is sent to a clearing entity (e.g., clearing entity 108). The information can include CUSIPS or other bond identifiers and bond lot information. This information can also be provided to the buyer of a TBA bond contract (e.g., buy side 106). The bonds satisfying the TBA bond contract may then be delivered on the settlement date.

Embodiments of the present invention may be used to buy and sell TBA bond contracts for a variety of bonds including corporate bonds and municipal bonds. Municipal bonds are an exemplary bond market where TBA bond contracts will facilitate increased trading and liquidity. For example, municipal bonds conventionally have low trade volume and involve time intensive trades. TBA bond contracts can be created that allow various municipal bonds to meet the general description or criteria, which makes it easier to trade and invest in municipal bonds. Such increased ease of trading and investing in municipal bonds will make it easier to raise capital via municipal bonds.

Corporate bonds are another exemplary market where TBA bond contracts will facilitate increased trading and liquidity. Increased liquidity in the bond market will likely make it easier to sell bonds. For example, corporate TBA bond contracts may make bond issuance more appealing as a way to raise capital as compared to loans or initial public offerings (IPOs).

Buy side 106 purchases bonds and TBA bond contracts from sell sides 104a-b. In one embodiment, buy side 106 purchases TBA bond contracts and bonds on the secondary market (e.g., bond market formed by sell sides 104a-b) from the sell side 104a. Buy side 106 can be a variety of entities including investors, asset managers, and institutional investors. Buy side 106 and sell sides 104a-b can engage in buying and selling bonds and TBA bond contracts. TBA bond contracts allow sell sides 104a-b and buy side 106 to gain exposure and eliminate exposure to bonds without gaining custody of the actual bonds.

Buy side 106 can purchase TBA bond contracts instead of searching for bonds that match their desired characteristics. Buy side 106 can initiate purchases of bonds by selecting a TBA bond contract that matches their desired characteristics. Buy side 106 may thus purchase a TBA bond contract, and on settlement, accept delivery of bonds that satisfy the general description of the TBA bond contract. For example, an institutional investor may buy a $20 million corporate TBA bond contract, and when the trade is settled, the institutional investor receives $20 million of actual corporate bonds. Additionally, buy side 106 could sell back their TBA bond contract positions (e.g., purchased TBA bond contracts) if buy side 106 does not want to take delivery of bonds on settlement.

Trades are registered with clearing entity 108, which provides clearing and settling of TBA bond contract trades. Clearing entity 108 defines criteria (e.g., publishes guidelines) that allow bonds to be considered part of a TBA bond contract. The TBA bond contract trading systems (e.g., bond trading system 600) and regulatory agencies (e.g., regulatory agency 630) check for compliance of bonds used in TBA bond contract trading. Clearing entity 108 may net out positions between two counter parties (e.g., sell side 104a and buy side 106). Clearing entity 108 can net outstanding buy and sell orders between two counter parties before settling, in order to minimize the number of transactions necessary to settle TBA bond contracts. For example, when there are buy and sell trades of the same amount of TBA bond contracts between two parties, the netting out of the positions may result in no bonds changing hands during settlement. In one embodiment, the clearing entity is the Depository Trust & Clearing Corporation (DTCC) of New York City, N.Y.

TBA bond contracts are fungible securities that describe the general characteristics (e.g., standard bond characteristics and sector of the issuer) of bonds that satisfy the TBA bond contract. A TBA bond contract thereby allows trading of a general description of classes of bonds, and then, when the trade settles, the actual bonds or pool of bonds are substituted to satisfy the general description. Bonds delivered during settlement may be determined at a point subsequent to the TBA bond contract trade, and multiple bonds may satisfy the general description. In one embodiment, there is a tolerance or variance that bonds delivered are required to be within for settling of a TBA bond contract. For example, bonds within a 98% tolerance or variance may be delivered to satisfy the general description of the TBA bond contracts. It is appreciated that some variance may be needed as the actual bonds themselves are not fungible securities.

The general description of a TBA bond contract may include a variety of characteristics including maturity, coupon (e.g., interest rate), callability, credit rating, and issuer sector (e.g., industry). For example, a corporate TBA bond contract may describe a set of characteristics including coupon, maturity, credit rating, issuer sector, and other factors that describe the bonds that are to be delivered at settlement. A corporate TBA bond contract may thus describe a fungible set of corporate bonds from multiple issuers (e.g., multiple corporations) with similar credit and sector characteristics. It is noted that bonds from two different issuers of matching characteristics would ideally be close in price, however, market sentiment for particular issuers (e.g., corporations or municipalities) affects bonds from that issuer. Accordingly, the process of defining TBA bond contracts may take market sentiment into account when sector memberships are defined.

The fungible nature of TBA bond contracts will likely facilitate more electronic trades (e.g., via an electronic communication network (ECN)) and more standardization, of bonds. This will allow bonds to be traded more frequently both as individual bonds and as TBA bond contracts. Electronic trading facilitates easier tracking of trades and makes settlements safer. TBA bond contracts, thereby, make trading easier and more suitable for meeting a variety of investment needs. For example, embodiments of the present invention may make it easier for portfolio managers to make bond trading decisions based on general market conditions (e.g., interest rates going up and down).

Embodiments of the present invention facilitate increased bond trading and liquidity as general descriptions of bonds may be traded via TBA bond contracts. Trading of bonds based on general descriptions, frees bond traders from trading in individual bonds, each having individual sets of characteristics. Such general descriptions result in time saving because individual bonds need not be sorted through. Inventory limits are further removed as settlement of TBA bond contracts occurs after a TBA bond contract trade. Bond traders may thus trade in and out of general descriptions, and upon settlement time, a netting of securities owed to a counter party by the clearing entity may take place. Embodiments of the present invention thus make it easier for investors, asset mangers, and dealers to invest in bonds or other fixed income securities.

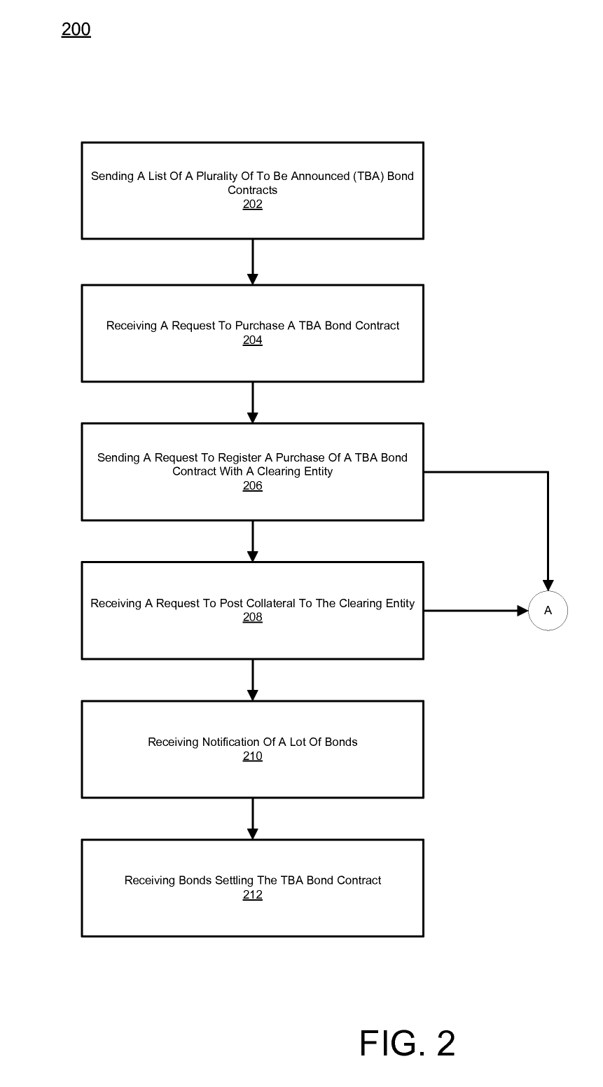

With reference to FIGS. 2-5, flowcharts 200, 300, 400, and 500 illustrate exemplary computer controlled processes for buying and selling TBA bond contracts used by various embodiments of the present invention. Although specific function blocks are shown in flowcharts 200, 300, 400, and 500, such steps are exemplary. That is, embodiments are well suited to performing various other blocks or variations of the blocks recited in flowcharts 200, 300, 400, and 500. It is appreciated that the blocks in flowcharts 200, 300, 400, and 500 may be performed in an order different than presented, and that not all of the blocks in flowcharts 200, 300, 400, and 500 may be performed.

FIG. 2 shows a flowchart of an exemplary process for buying a TBA bond contract, in accordance with an embodiment of the present invention. Portions of process 200 can be carried out by an electronic system (e.g., computing system environment 700 and/or bond trading system 600). It is appreciated that TBA bond contracts may be bought and sold by both dealers (e.g., sell sides 104a-b) and investors (e.g., buy side 106).

At block 202, a list of a plurality of to be announced (TBA) bond contracts is sent. In one embodiment, the list of TBA bond contracts is sent from a bond trading system (e.g., system 600) and presented via a graphical user interface (GUI) to a potential investor (e.g., buy side 104a).

At block 204, a request to purchase a TBA bond contract is received via an electronic system (e.g., computing system 700). The request can be received from a buyer (e.g., buy side 106 or sell sides 104a-b). As described herein, TBA bond contracts may include a variety of bonds including corporate bonds and municipal bonds. The TBA bond contract includes a general description of bond characteristics that the TBA bond contract represents. For example, a TBA bond contract may have a general description of: a maturity date of 15 years, an “A” credit rating, a coupon of 4.5%, and a total amount of $100 million.

At block 206, a request is sent to register a purchase of a TBA bond contract with a clearing entity. As described herein, the trade may be registered with clearing entity 108 that is operable to provide clearing and settlement of the trade. Block 302 may then be performed if the TBA bond contract position is to be sold.

At block 208, a request to post collateral to the clearing entity is received. In one embodiment, collateral is posted to the clearing entity in the form of treasuries or other safe security. It is appreciated that various TBA bond contract trading systems may have a variety of trading conventions as to whether collateral is to be posted. In one embodiment, a buyer of a TBA bond contract need not post collateral as cash or other payment has already been paid for the TBA bond contract. Block 302 may then be performed if the TBA bond contract position is to be sold.

At block 210, notification of a lot of bonds is received. A lot of bonds is the normal or standard unit of trading of bonds. In one embodiment, the notification is received within a predetermined time before a settlement deadline. The notification may include information (e.g., CUSIPS) of the actual bonds (e.g., corporate or municipal bonds) that will be used to settle the TBA bond contract.

At block 212, a lot of bonds is received satisfying the TBA bond contract. The bonds received by the TBA bond contract buyer (e.g., buy side 106) settle the trade corresponding to the TBA bond contract. As described herein, bonds settling the TBA bond contract trade can be delivered within a variance of the general description of the TBA bond contract.

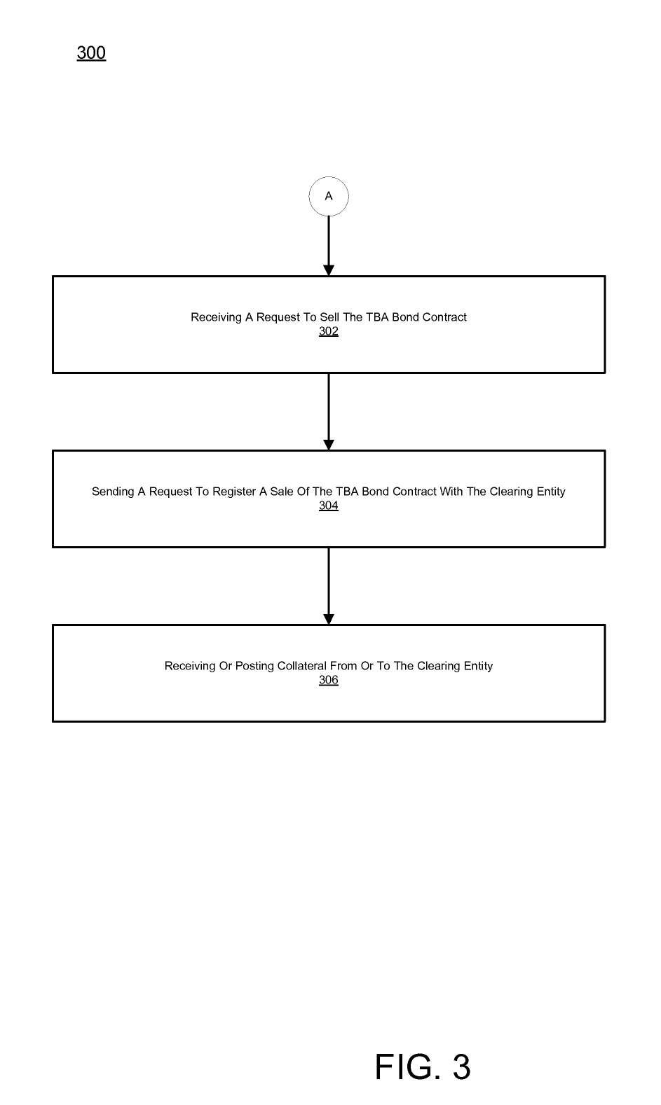

FIG. 3 shows a flowchart of an exemplary process for closing a purchased TBA bond contract position, in accordance with another embodiment of the present invention. Portions of process 300 may be carried out by an electronic system (e.g., computing system environment 700). It is appreciated that TBA bond contract positions may be closed by both dealers (e.g., sell sides 104a-b) and investors (e.g., buy side 106) prior to settlement.

At block 302, a request to sell the TBA bond contract is received. The TBA bond contract that was purchased can be sold to close the position. The TBA bond contract can be sold (e.g., by buy side 106) back to the party that sold the TBA bond contract (e.g., sell side 104a) or another counter party (e.g., sell side 104b or other buyer). In one embodiment, the TBA bond contract is sold prior to a pre-settlement period (e.g., a predetermined time before settlement when trading of the TBA bond contract is stopped). The seller of the TBA bond contract can receive cash or other form of payment in exchange for the TBA bond contract. The selling of the TBA bond contract can release the buyer from obligations of the TBA bond contract.

At block 304, a request to register a sale of the TBA bond contract is sent to the clearing entity. As described herein, TBA bond contract trades are registered with a clearing entity that clears and settles TBA bond contract trades.

At block 306, collateral is optionally posted to or received from the clearing entity. In one embodiment, collateral can be posted (e.g., due to shift in TBA bond contract prices) to the clearing entity prior to settling of the TBA bond contract. Collateral can be received from a counter party via the clearing entity. When the pre-settlement period arrives, if the TBA bond contract position has been closed (e.g., by selling it back to the original counter party or another counter party), no collateral may need to change hands. The clearing entity (e.g., clearing entity 108) is responsible to net out the positions such that there is a minimum amount of actual bonds actually changing hands.

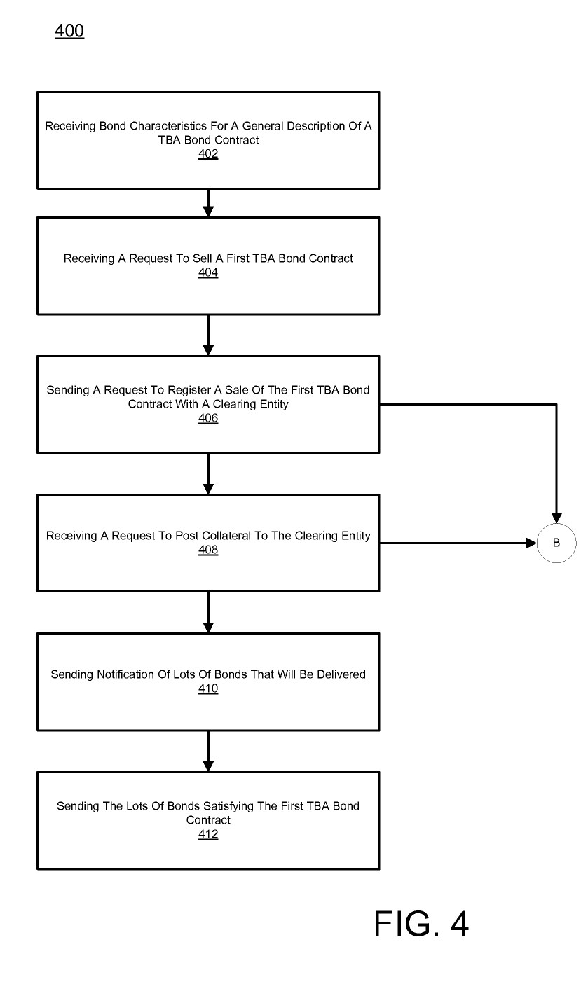

FIG. 4 shows a flowchart of an exemplary process for selling a TBA bond contract, in accordance with an embodiment of the present invention. Portions of process 400 may be carried out by an electronic system (e.g., computing system environment 700). It is appreciated that TBA bond contracts may be bought and sold by both dealers (e.g., sell sides 104a-b) and investors (e.g., buy side 106).

At block 402, bond characteristics are received for a general description of a TBA bond contract. In one embodiment, a TBA bond contract general description is selected via a GUI of a TBA bond contract trading system or platform (e.g., system 600). At block 404, a request is received to sell a first TBA bond contract is received via an electronic system (e.g., computing system 700). The first TBA bond contract has a general description based on the received bond characteristics.

At block 406, a request to register a sale of the first TBA bond contract is sent to a clearing entity. The request is sent to the clearing entity (e.g., DTCC) for clearing and settling trades. Block 502 may then be performed if the TBA bond contract position is to be closed prior to settlement.

At block 408, a request to post collateral to the clearing entity is received. Collateral is optionally posted to or received from the clearing entity. If the TBA bond contract is the only transaction between two parties, then collateral may need to be posted. As described herein, the seller of a TBA bond contract may be required to post collateral to the clearing entity based on changes in the price of the TBA bond contract. For example, if the market moves against a position (e.g., interest rates increase), collateral or additional collateral may need to be posted. Block 502 may then be performed if the TBA bond contract position is to be closed prior to settlement.

At block 410, notification is sent of a lot of bonds that will be delivered. The clearing entity is notified by the party that sold the TBA bond contract (e.g., sell side 104a) of bonds that will be delivered to fulfill the TBA bond contract. The notification can include CUSIPS of bonds in the lot of bonds that will be delivered. As described herein, the notification is sent during a predetermined time period when trading of the first TBA bond contract has been stopped prior to a settlement deadline (e.g., 24 to 48 hours).

At block 412, a lot of bonds satisfying the first TBA bond contract is delivered. The delivery of bonds satisfying the TBA bond contract settles the TBA bond contract trade. In one embodiment, netting of trades between two parties (e.g., counter parties, such as buy side 106 and sell side 104a) is determined by the clearing entity, and bonds are delivered accordingly.

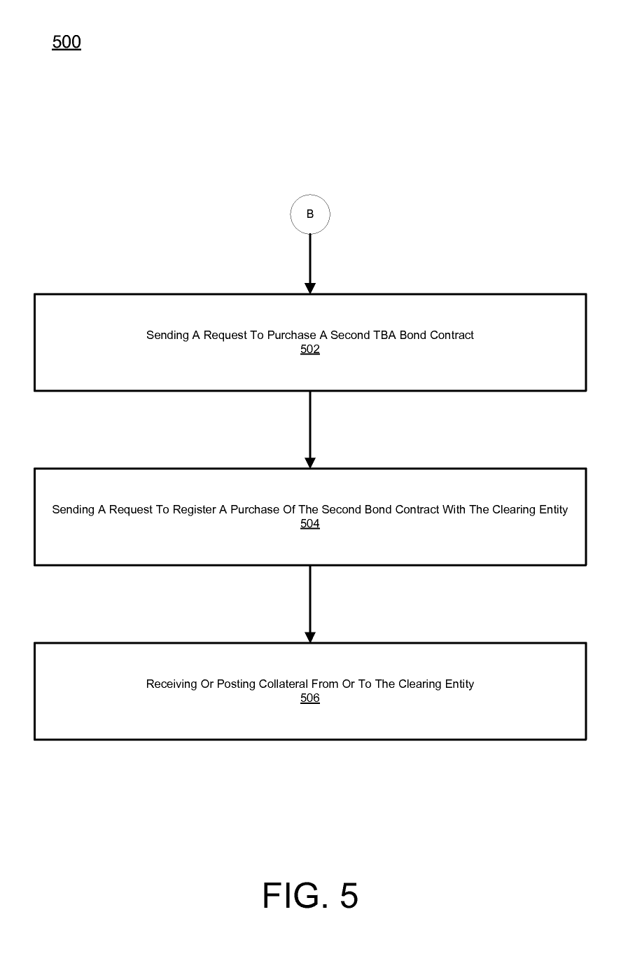

FIG. 5 shows a flowchart of an exemplary process for closing a sold TBA bond contract position, in accordance with an embodiment of the present invention. Portions of process 500 may be carried out by an electronic system (e.g., computing system environment 700). TBA bond contract positions may be closed by both dealers (e.g., sell sides 104a-b) and investors (e.g., buy side 106) prior to settlement.

At block 502, a request is sent to purchase a second TBA bond contract. A party (e.g., sell side 104a) may buy the first TBA bond contract from the original counter party that purchased the first TBA bond contract (e.g., buy side 106) or purchase a second TBA bond contract from another party, to close the prior position of selling the first TBA bond contract.

At block 504, a request is sent to register a purchase of the second TBA bond contract to the clearing entity. As described herein, the TBA bond contract trades may be registered with a clearing entity which clears and settles TBA bond contract trades.

At block 506, collateral may optionally be posted to or received from the clearing entity. In one embodiment, the party that sold the first TBA bond contract (e.g., sell side 104a) may receive collateral that was posted (e.g., due to shifts in TBA bond contract prices) from the clearing entity. When the pre-settlement period arrives, if the first TBA bond contract position has been closed (e.g., by buying a TBA bond contract back from the original counter party or another counter party), no collateral may need to change hands. The clearing entity (e.g., clearing entity 108) is responsible to net out the positions such that there is a minimum amount of actual bonds actually changing hands.

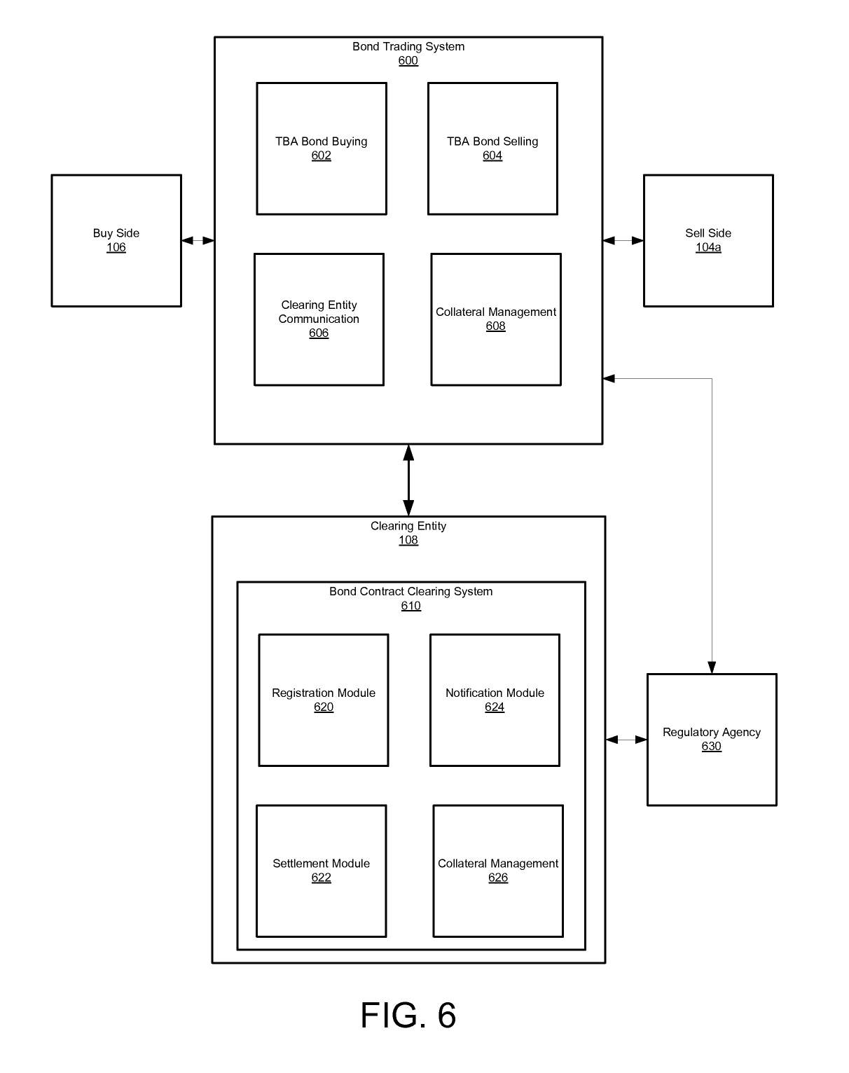

FIG. 6 illustrates exemplary components used by various embodiments of the present invention. Although specific components are disclosed in system 600, it should be appreciated that such components are exemplary. That is, embodiments of the present invention are well suited to having various other components or variations of the components recited in system 600. It is appreciated that the components in system 600 may operate with other components than those presented.

FIG. 6 shows a block diagram of exemplary components of a TBA bond contract trading system, in accordance with an embodiment of the present invention. TBA bond contract trading system 600 includes TBA bond contract buying module 602, TBA bond contract selling module 604, clearing entity communication module 606, and collateral management module 608. System 600 communicates with TBA bond contract purchasers (e.g., buy side 106) and TBA bond contract sellers (e.g., sell sides 104a-b), regulatory agency 630, and clearing entities (e.g., clearing entity 108). In one embodiment, system 600 can perform settling and clearing of TBA bond contracts, as described herein.

TBA bond contract buying module 602 is operable to perform activities related to buying a TBA bond contract. As described herein, TBA bond contract buying module 602 may be used by a buyer (e.g., buy side 106) or seller (e.g., sell side 106a to close a position) to buy TBA bond contracts. TBA bond contract buying module 602 facilitates TBA bond contract purchasing by allowing browsing of TBA bond contracts and corresponding general descriptions. TBA bond buying module 602 is operable to receive notification of a lot of bonds corresponding to a TBA bond contract (e.g., a lot of bonds to be delivered to fulfill a TBA bond contract). TBA bond buying module 602 is further operable to receive a lot of bonds (e.g., bond identifiers) corresponding to a TBA bond contract for settling the TBA bond contract.

TBA bond contract selling module 604 is operable to perform activities related to selling a TBA bond contract. As described herein, TBA bond contract selling module 604 may be used by a seller (e.g., sell side 106a) or a buyer (e.g., buy side 106 to close a position) to sell TBA bond contracts. TBA bond contract selling module 604 is operable to facilitate selection of bond characteristics for a general description of a TBA bond contract to be sold. In one embodiment, TBA bond contract selling module 604 is operable to send notification of a lot of bonds corresponding to the TBA bond contract (e.g., a lot of bonds to be delivered to fulfill a TBA bond contract). The notification may be sent to a clearing entity and a buyer of the TBA bond contract, as described herein. TBA bond contract selling module 604 is further operable to deliver a lot of bonds corresponding to the TBA bond contract for settling the TBA bond contract.

System 600 further includes clearing entity communication module 606 operable to communicate with a clearing entity related to a buy trade and a sell trade of a TBA bond contract, as described herein. In one embodiment, system 600 further includes collateral management module 608 for posting or receiving collateral related to a TBA bond contract trade, as described herein.

Clearing entity 108 communicates with the bond trading system 600, regulatory agency 630, and may optionally communicate with buy side 106 and sell side 104a. Regulatory agency 630 checks TBA bond contract trades via bond trading system 600 and clearing entity 108 for compliance with the criteria defined by clearing entity 108 for bonds to be part of a TBA bond contract trade. In one embodiment, the Financial Industry Regulatory Authority (FINRA) checks for compliance of bonds for corporate TBA bond contract trades and the Municipal Securities Rulemaking Board (MSRB) checks for compliance of bonds for municipal TBA bond contact trades.

Clearing entity 108 includes TBA bond contract clearing system 610. TBA bond contract clearing system 610 is operable to clear and settle TBA bond contract trades (e.g., between buy side 106 and sell side 104a). TBA bond contract clearing system 610 includes registration module 620, settlement module 622, notification module 624, and collateral management module 626. TBA bond contract clearing system 610 may clear trades for a variety of TBA bond contracts including corporate TBA bond contracts and municipal TBA bonds contracts.

Registration module 620 is operable to receive requests to register a sale and a purchase of a TBA bond contract. Requests to register a sale and a purchase of the TBA bond contract can be sent from a TBA bond contract trading system (e.g., system 600). Settlement module 622 is operable to net out a plurality of bond contract positions between a seller of the bond contract and a buyer of the bond contract, as described herein. Notification module 624 is operable to receive notification of a lot of bonds to be used for settling the bond contract. Collateral management module 626 is operable to receive and send collateral related to the TBA bond contract to a TBA bond contract trading system (e.g., system 600).

FIG. 7 shows a block diagram of an exemplary computing system environment 700, in accordance with one embodiment of the present invention. With reference to FIG. 7, an exemplary system module for implementing embodiments includes a general purpose computing system environment, such as computing system environment 700. Computing system environment 700 may include, but is not limited to, servers, desktop computers, laptops, tablet PCs, mobile devices, and smartphones. In its most basic configuration, computing system environment 700 typically includes at least one processing unit 702 and computer readable storage medium 704. Depending on the exact configuration and type of computing system environment, computer readable storage medium 704 may be volatile (such as RAM), non-volatile (such as ROM, flash memory, etc.) or some combination of the two. Portions of computer readable storage medium 704 when executed perform various TBA bond contract trading tasks (e.g., processes 200, 300, 400, and 500) or operations of a TBA bond contract trading system (e.g., system 600).

Additionally, computing system environment 700 may also have additional features/functionality. For example, computing system environment 700 may also include additional storage (removable and/or non-removable) including, but not limited to, magnetic or optical disks or tape. Such additional storage is illustrated in FIG. 7 by removable storage 708 and non-removable storage 710. Computer storage media includes volatile and nonvolatile, removable and non-removable media implemented in any method or technology for storage of information such as computer readable instructions, data structures, program modules or other data. Computer readable medium 704, removable storage 708 and nonremovable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 700. Any such computer storage media may be part of computing system environment 700.

Computing system environment 700 may also contain communications connection(s) 712 that allow it to communicate with other devices. Communication connection(s) 712 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 712 may allow computing system environment 700 to communication over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 712 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 700 may also have input device(s) 714 such as a keyboard, mouse, pen, voice input device, touch input device, remote control, etc. Output device(s) 716 such as a display, speakers, etc. may also be included. All these devices are well known in the art and are not discussed at length.

In one embodiment, computer readable storage medium 704 includes TBA bond contract trading platform 706. The TBA bond contract trading platform 706 allows trading of TBA bond contracts based on general description, as described herein. TBA bond contract trading platform 706 may be used by a clearing entity (e.g., clearing entity 108), a TBA bond contract buyer (e.g., buy side 106), and a TBA bond contract seller or dealer (e.g., sell sides 104a-b).

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for buying bonds comprising:
receiving a request to purchase a bond contract, in an electronic system, wherein said bond contract comprises a description of bonds that settle said bond contract;
sending a request to register a purchase of said bond contract with a clearing entity;
receiving a notification of a plurality of bonds to be used to settle said bond contract; and
receiving said plurality of bonds, wherein said plurality of bonds settles said bond contract.

2. The method as described in claim 1 further comprising:
receiving a request to post collateral to said clearing entity.

3. The method as described in claim 1 further comprising:
sending a list of a plurality of bond contracts.

4. The method as described in claim 1 further comprising:
receiving a request to sell said bond contract;
sending a request to register a sale of said bond contract with said clearing entity; and
receiving collateral from said clearing entity.

5. The method as described in claim 1 wherein said bond contract is a corporate bond contract.

6. The method as described in claim 1 wherein said bond contract is a municipal bond contract.

7. The method as described in claim 1 wherein said plurality of bonds is within a variance of said description of said bond contract.

8. The method as described in claim 1 wherein said notification of said plurality of bonds is received within a predetermined time before settlement of said bond contract.

9. The method as described in claim 1 wherein said clearing entity clears and settles said bond contract.

10. A method for selling bonds comprising:
receiving a request to sell a first bond contract, in an electronic system, wherein said first bond contract comprises a description of bonds that settle said bond contract;
sending a request to register a sale of said first bond contract with a clearing entity;
sending a notification to said clearing entity of a plurality of bonds that will be delivered to satisfy said first bond contract; and
sending said plurality of bonds, wherein said plurality of bonds settles said first bond contract.

11. The method of claim 10 further comprises:
receiving a request to purchase a second bond contract; and
sending a request to register a purchase of said second bond contract with said clearing entity.

12. The method of claim 11 further comprises:
receiving a request to post collateral to said clearing entity.

13. The method of claim 10 further comprising:
sending a request for collateral to be posted to said clearing entity.

14. The method of claim 10 further comprising:
receiving a plurality of bond characteristics for said description of said bond contract.

15. The method of claim 10 wherein said description of said bond contract comprises a plurality of corporate bond characteristics.

16. The method of claim 10 wherein said description of said bond contract comprises a plurality of municipal bond characteristics.

17. The method of claim 10 wherein said plurality of bonds is within a predetermined variance of a description of said bond contract.

18. The method of claim 10 wherein said notification to said clearing entity is sent within a predetermined time before a settlement deadline.

19. The method of claim 10 wherein said clearing entity clears and settles said bond contract.

20. A bond trading system comprising:
a bond contract buying module operable to perform activities related to buying a first bond contract, wherein said first bond contract comprises a first description of bonds that satisfy said first bond contract;
a bond contract selling module operable to perform activities related to selling a second bond contract, wherein said second bond contract comprises a second description of bonds that satisfy said second bond contract; and
a clearing entity communication module operable to communicate with a clearing entity regarding said activities related to said buying of said first bond contract and said selling of said second bond contract.

21. The system of claim 20 wherein the system further comprises:
a collateral management module operable for posting and receiving collateral related to said first and said second bond contract.

22. The system of claim 20 wherein said bond contract buying module is operable to receive notification of a plurality of bonds corresponding to said first bond contract.

23. The system of claim 20 wherein said bond contract buying module is operable to receive a plurality of bonds corresponding to said first bond contract.

24. The system of claim 20 wherein said bond contract buying module is operable to facilitate browsing of a plurality of bond contracts and corresponding descriptions.

25. The system of claim 20 wherein said bond contract selling module is operable to send notification of a plurality of bonds corresponding to said second bond contract.

26. The system of claim 20 wherein said bond selling module is operable to deliver a plurality of bonds corresponding to said second bond contract.

27. The system of claim 20 wherein said bond contract selling module is operable to facilitate selection of a plurality of bond characteristics for said description of said second bond contract.

28. The system of claim 20 wherein said clearing entity clears and settles said bond contract.

29. A bond trading system comprising:
a bond contract buying module operable to perform activities related to buying a bond contract, wherein said bond contract comprises a description of bonds that satisfy said bond contract;
a bond contract selling module operable to perform activities related to selling said bond contract; and
a clearing entity communication module operable to communicate with a clearing entity regarding said activities related to said buying and said selling of said bond contract.

30. The system of claim 29 wherein the system further comprises:
a collateral management module operable for posting and receiving collateral related to said bond contract.

31. The system of claim 29 wherein said bond contract buying module is operable to receive notification of a plurality of bonds corresponding to said bond contract.

32. The system of claim 29 wherein said bond contract buying module is operable to receive a plurality of bonds corresponding to said bond contract.

33. The system of claim 29 wherein said bond contract buying module is operable to facilitate browsing of a plurality of bond contracts and corresponding descriptions.

34. The system of claim 29 wherein said bond contract selling module is operable to send notification of a plurality of bonds corresponding to said bond contract.

35. The system of claim 29 wherein said bond contract selling module is operable to deliver a plurality of bonds corresponding to said bond contract.

36. The system of claim 29 wherein said bond contract selling module is operable to facilitate selection of a plurality of bond characteristics for a description of said bond contract.

37. A bond contract clearing system comprising:
a registration module operable to receive requests to register a sale and a purchase of a bond contract, wherein said bond contract comprises a description of bonds that settle said bond contract;
a settlement module operable to net out a plurality of bond contract positions between a seller of said bond contract and a buyer of said bond contract; and
a notification module operable to receive notification of a plurality of bonds to be used for settling said bond contract.

38. The system of claim 37 further comprising:
a collateral management module operable to receive collateral related to said bond contract.

39. The system of claim 37 wherein said bond contract is a corporate bond contract.

40. The system of claim 37 wherein said bond contract is a municipal bond contract.
